(19) United States
(12) Patent Application Publication
(10) Pub. No.: US 2003/0108278 A1
(43) Pub. Date: Jun. 12, 2003

(54) Optical switch having routing indicators

(76) Inventor: Yao-Hao Chang, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/099,847

(22) Filed: Mar. 14, 2002

(30) Foreign Application Priority Data
Dec. 12, 2001 (TW) 90221690

(51) Int. Cl. G02B 6/35; G02B 6/34

(52) U.S. Cl. 385/21; 385/16; 385/36

(57) ABSTRACT

An optical switch (10) includes two input optical fibers (21, 22) for inputting light beams, two output optical fibers (41, 42) for receiving the light beams, a path-switching assembly (30) having a prism (321) for switching paths of the light beams, a relay (33) having a controlling circuit for controlling the path-switching assembly, two input indicators (71, 72), and two output indicators (73, 74). The path-switching assembly has a first operative state in which the prism is moved out of a path of the light beams, and a second operative state in which the prism is moved into the path. The input indicators are single color LEDs that can respectively display orange and green. The output indicators both are double color LEDs, and each can display orange and green. The output indicators instantly change color upon a change in the status of light routing of the optical switch.

### BACKGROUND OF THE INVENTION

1. Field of the Invention

The present invention relates to optical switches, and particularly to an optical switch having light-emitting diodes (LEDs) as light routing indicators.

2. Description of Related Art

Optical switches are required in numerous fiber optic systems. For example, optical switches redirect light from one optical fiber to another. Optical switches are classified into mechanical and non-mechanical switches. In mechanical switches, the switching function is generally performed by mechanical means.

U.S. Pat. No. 4,322,126 discloses a 2×2 mechanical optical switch. The mechanical optical switch has a prism, a switching means for controlling the prism, first and second input optical fibers, and first and second output optical fibers. The prism is a hexagonal prism for exchanging optical paths of two initially parallel light beams transmitted from the input optical fibers. The input and output optical fibers are respectively attached to opposite ends of the prism. When the prism is moved out of a path of the light beams by the switching means, the light beams emitting from the first and second input optical fibers are respectively directed into the first and second output optical fibers. When the prism is moved into the path of the light beams, the light beams emitting from the first and second input optical fibers are crossed over by the prism and respectively directed into the second and first output optical fibers. However, the actual light routing status of the light beams of such optical switch is not apparent to an operator. Therefore, the optical switch is liable to be improperly operated by the operator.

### SUMMARY OF THE INVENTION

Accordingly, an object of the present invention is to provide an optical switch having indicators which show a light routing status of the optical switch.

In order to achieve the object set above, an optical switch in accordance with the present invention comprises an input assembly, an output assembly, a path-switching assembly, first and second input indicators and first and second output indicators. The input assembly is attached to a front portion of the path-switching assembly, and the output assembly is attached to a rear portion of the path-switching assembly. The path-switching assembly comprises a platform, a relay and a pivoting mechanism having a prism. The relay is mounted on a front portion of the platform, and controls the pivoting mechanism to move the prism into or out of a path of light beams in the path-switching assembly. The first and second input indicators are single color LEDs, and can respectively display an orange color and a green color. The first and second output indicators both are double color LEDs, and each can display an orange color and a green color. The first and second output indicators instantly change color upon a change in the status of light routing of the optical switch.

Other objects, advantages and novel features of the invention will become more apparent from the following detailed description when taken in conjunction with the accompanying drawings, in which:

### BRIEF DESCRIPTION OF THE DRAWINGS

FIG. 1 is a perspective view of an optical switch in accordance with the present invention;

FIG. 2 is an exploded perspective view of the optical switch of FIG. 1;

FIG. 3 is a partly assembled view of the optical switch of FIG. 2, showing a first operative state thereof;

FIG. 4 is similar to FIG. 3, but showing a second operative state;

FIG. 5 is similar to FIG. 3, but viewed from another aspect;

FIG. 6 is a bottom plan view of the optical switch of FIG. 1;

FIG. 7 is a schematic internal circuit diagram of a relay of the optical switch of FIG. 1, showing the first operative state thereof; and

FIG. 8 is similar to FIG. 7, but showing the second operative state.

### DETAILED DESCRIPTION OF PREFERRED EMBODIMENT

Reference will now be made to the drawings to describe the present invention in detail.

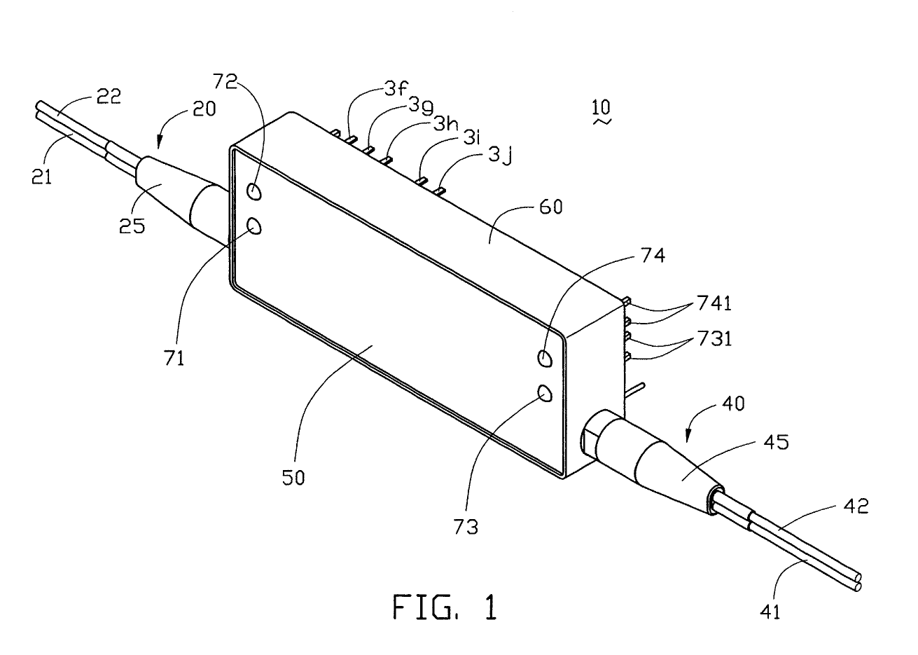

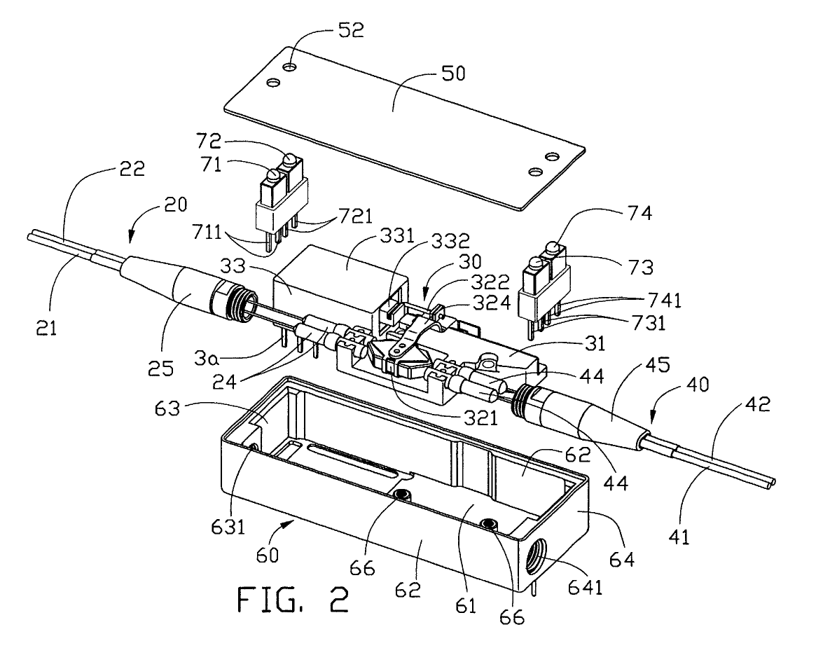

Referring to FIGS. 1 and 2, an optical switch 10 in accordance with the present invention comprises an input assembly 20, an output assembly 40, a path-switching assembly 30, first and second input indicators 71, 72, first and second output indicators 73, 74, an upper cover 50 and a lower cover 60. The input assembly 20 is attached to a front portion of the path-switching assembly 30, and the output assembly 40 is attached to a rear portion of the path-switching assembly 30.

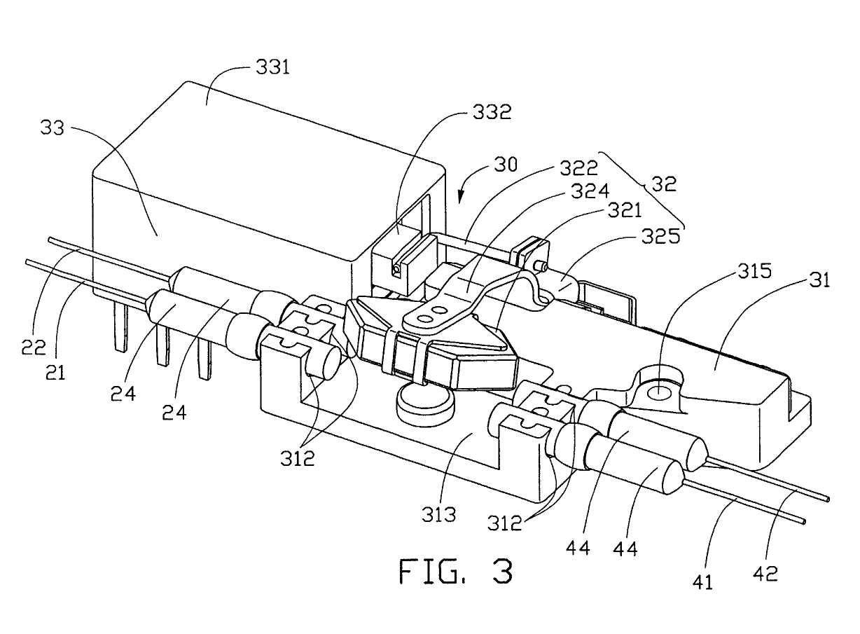

The input assembly 20 comprises first and second input optical fibers 21, 22, two collimators 24 (see FIG. 3), and a first strain relief boot 25. Each input optical fiber 21, 22 is attached to one end of a corresponding collimator 24. The first strain relief boot 25 retains the input optical fibers 21, 22 and portions of the collimators 24 therein.

The output assembly 40 comprises first and second output optical fibers 41, 42, two collimators 44 (see FIG. 3), and a second strain relief boot 45. Each output optical fiber 41, 42 is attached to one end of a corresponding collimator 44. The second strain relief boot 45 retains the output optical fibers 41, 42 and portions of the collimators 44 therein.

The first and second input indicators 71, 72 are single color LEDs, and can respectively display an orange color and a green color. The first and second output indicators 73, 74 are double color LEDs. Each first and second output indicator 73, 74 can display both orange and green colors. Each input and output indicator 71, 72, 73, 74 respectively comprises a pair of conductive pins 711, 721, 731, 741, for electrical connection with an external controlling circuit (not shown).

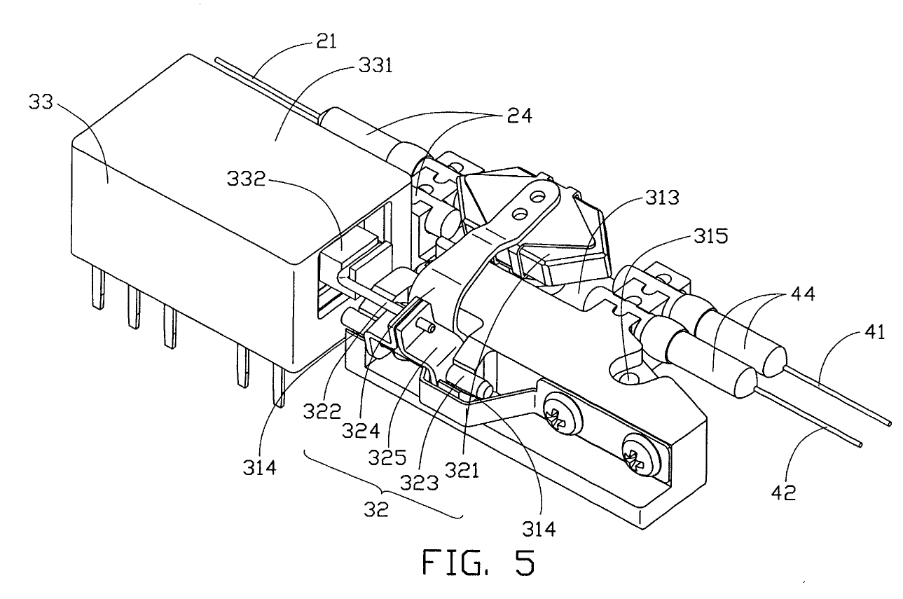

Referring to FIGS. 3-5, the path-switching assembly 30 comprises a platform 31, a pivoting mechanism 32 having a prism 321, and a relay 33 mounted on a front portion of platform 31. A pair of retaining cutouts 312 is defined in each of the front portion and a rear portion of the platform 31, for retention of the collimators 24, 44 of the input and output assemblies 20, 40 therein respectively. A depression 313 is defined in an intermediate portion of the platform 31, for reception of the prism 321. The pivoting mechanism 32 comprises the prism 321, an L-shaped rod 322, a shaft 323, and a switching arm 324 having a pivoting portion 325. The pivoting portion 325 defines a first set of through holes (not labeled) and a second set of through holes (not labeled) therein. The shaft 323 extends through the first set of through holes of the pivoting portion 325. Two retaining recesses 314 are respectively defined in the front and rear portions of the platform 31, for retaining opposite ends of the shaft 323. A first portion (not labeled) of the L-shaped rod 322 extends through the second set of through holes, for driving the switching arm 324 to rotate with respect to the shaft 323. The prism 321 is generally a hexagonal prism. The prism 321 is retained by a free end (not labeled) of the switching arm 324, for exchanging optical paths of two initially parallel beams transmitted from the input optical fibers 21, 22. Two first through holes 315 are defined in the platform 31, for extension of two screws (not shown) therethrough.

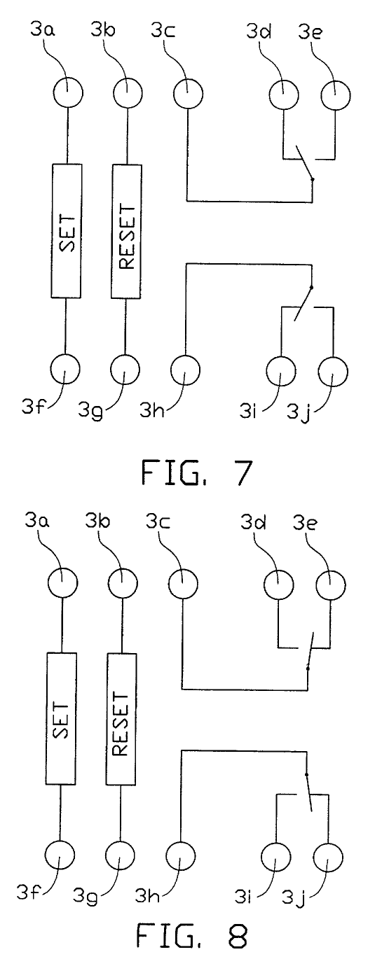

The relay 33 comprises a housing 331, a movable block 332, driving means (not visible) for driving the movable block 332, an internal controlling circuit (shown in FIGS. 7 and 8) for controlling the driving means, first and second sets of controlling conductive pins 3a, 3f, and 3b, 3g for controlling the driving means, and six monitoring conductive pins 3c, 3d, 3e, 3h, 3i, 3j for monitoring and feeding light routing status back to the external controlling circuit. The conductive pins 3a-3j and the input and output indicators 71-74 are electrically connected with the external controlling circuit (not shown). Connections of the monitoring conductive pins 3c, 3d, 3e, 3h, 3i, 3j have a first operative state in which 3c and 3h are respectively electrically connected with 3d and 3i (see FIG. 7), and a second operative state in which 3c and 3h are respectively electrically connected with 3e and 3j (see FIG. 8). The movable block 332 defines a retaining groove 333, for tightly retaining a second portion (not labeled) of the L-shaped rod 322 therein.

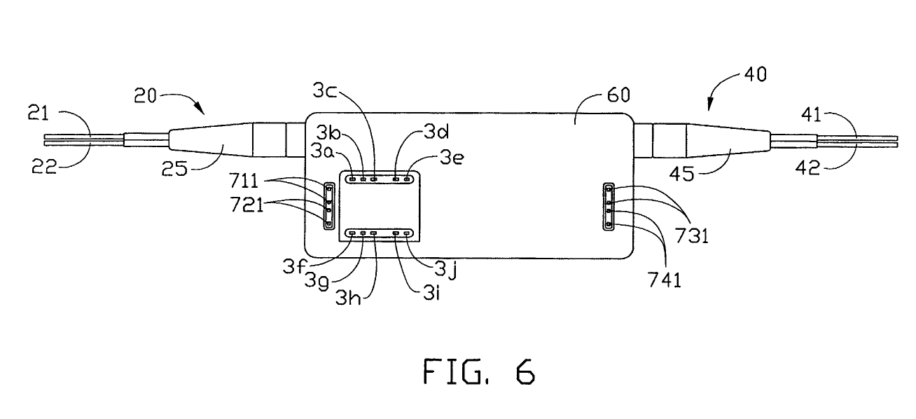

The upper cover 50 defines two pairs of second through holes 52 for exposing the corresponding input and output indicators 71-74. The lower cover 60 comprises a bottom wall 61, front and rear walls 63, 64, and two sidewalls 62. Two first screw holes 631, 641 are respectively defined in the front and rear walls 63, 64, for threaded engagement therein of the strain relief boots 25, 45 of the input and output assemblies 20, 40 respectively. Two second screw holes 66 are defined in the bottom wall 61 of the lower cover 60, for extension of the two screws (not shown) thereinto. Four cutouts (not labeled, best seen in FIG. 6) are defined in the bottom wall 61 of the lower cover 60, for extension of the conductive pins 3a-3j of the relay 33 and the conductive pins 711, 721, 731, 741 of the input and output indicators 71-74 therethrough.

In assembly, the pivoting mechanism 32 is mounted to the platform 31 of the path-switching assembly 30. The second portion of the L-shaped rod 322 is tightly retained in the retaining groove 333 of the movable block 332 of the relay 33. The opposite ends of the shaft 323 are respectively retained in the retaining recesses 314 of the platform 31. The two screws (not shown) are extended through the first through holes 315 of the platform 31 to engage in the second screw holes 66 of the bottom wall 61 of the lower cover 60. The platform 31 is thus fixed to the lower cover 60. The upper and lower covers 50, 60 are attached together by conventional means. The path-switching assembly 30, the input and output indicators 71-74, and portions of the input and output assemblies 20, 40 are thus tightly encased by the upper and lower covers 50, 60. The first and second strain relief boot 25, 45 of the input and output assemblies 20, 40 are respectively it threadedly engaged in the first screw holes 631, 641 of the lower cover 60.

In operation, optical signals are input from the first and second input optical fibers 21, 22. The first and second input indicators 71, 72 respectively display orange and green colors. With reference to FIGS. 3 and 7, when the first set of controlling conductive pins 3a, 3f are closed and the second set of controlling conductive pins 3b, 3g are opened via the external controlling circuit, the driving means drives the movable block 332 sideways from a first position to a second position. The switching arm 324 is thus rotated relative to the shaft 323, and carries the prism 321 out of a path of light beams in the path-switching assembly 30. The monitoring conductive pins thereupon automatically change to the first operative state. That is, the monitoring conductive pins 3c, 3h respectively electrically connect with the monitoring conductive pins 3d, 3i. The first operative state of the monitoring conductive pins 3c, 3d, 3e, 3h, 3i, 3j is then detected by the external controlling circuit, which instantly actuates the first and second output indicators 73, 74 to respectively display the orange color and the green color.

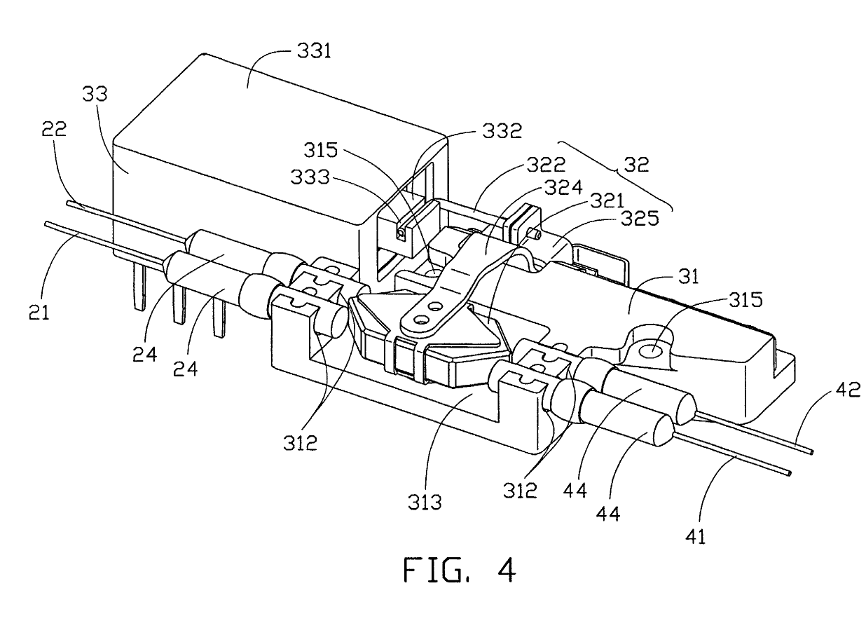

Referring to FIGS. 4 and 8, when the second set of controlling conductive pins 3b, 3g are closed and the first set of controlling conductive pins 3a, 3f are opened, the driving means drives the movable block 332 from the second position back to the first position. The prism 321 is thus carried by the switching arm 324 back into the path of light beams. The monitoring conductive pins thereupon automatically change to the second operative state. That is, the monitoring conductive pins 3c, 3h respectively electrically connect with the monitoring conductive pins 3e, 3j. The second operative state of the monitoring conductive pins 3c, 3d, 3e, 3h, 3i, 3j is then detected by the external controlling circuit, which instantly actuates the first and second output indicators 73, 74 to respectively to display the green color and the orange color. Thus, light routing status of the optical switch 10 is conveniently shown.

While the preferred embodiment in accordance with the present invention has been shown and described, equivalent modifications and changes known to persons skilled in the art according to the spirit of the present invention are considered within the scope of the present invention as defined in the appended claims. For example, the switch may be applied to the N×N arrangement instead of the 2×2 one disclosed in the embodiment.

1. An optical switch comprising:
input collimating means;
output collimating means;
a first input optical fiber and a second input optical fiber both attached to the input collimating means for transmitting light beams;
a first output optical fiber and a second output optical fiber both attached to the output collimating means for receiving the light beams;
a pivoting mechanism comprising a prism;
a relay having an internal circuit controlling the pivoting mechanism, the internal circuit having a first operative state and a second operative state;
a first input indicator and a second input indicator that can respectively displaying a first color and a second color; and
a first output indicator and a second output indicator;
wherein
when the internal circuit of the relay is in the first operative state, the first input indicator displays the first color, the second input indicator displays the second color, the pivoting mechanism causes the prism to be placed out of a path of the light beams transmitted from the first and second input optical fibers, the first output indicator displays the first color, and the second output indicator displays the second color; and
when the internal circuit of the relay is in the second operative state, the first input indicator displays the first color, the second input indicator displays the second color, the pivoting mechanism causes the prism to be placed in the path of the light beams transmitted from the first and second input optical fibers, the first output indicator displays the second color, and the second output indicator displays the first color.

2. The optical switch as described in claim 1, wherein the first and second input indicators each are generally single color light-emitting diodes.

3. The optical switch as described in claim 1, wherein the first and second output indicators each are generally double color light-emitting diodes.

4. An optical switch comprising:
a plurality of pairs of input ports;
a plurality of pairs of output ports;
a plurality of pivoting mechanisms, each of the pivoting mechanisms comprising a prism;
a plurality of relays, each of the relays corresponding to a pair of input ports, each of the relays having an internal circuit for controlling a corresponding pivoting mechanism, the internal circuit having a first operative state and a second operative state;
a plurality of pairs of input indicators, each of the input indicators in any one pair of input indicators being able to display a predetermined single color representing one of the input ports of a corresponding pair of input ports; and
a plurality of pairs of output indicators;
wherein when the internal circuit of any one of the relays is in the first operative state, a first input indicator of the corresponding pair of input indicators displays a first predetermined single color, a second input indicator of the corresponding pair of input indicators displays a second predetermined single color, the corresponding pivoting mechanism causes the corresponding prism to be placed out of a path of light beams transmitted from the corresponding pair of input ports, a first output indicator of a corresponding pair of output indicators displays the first predetermined single color, and a second output indicator of the corresponding pair of output indicators displays the second predetermined single color; and
when the internal circuit of said any one of the relays is in the second operative state, the first input indicator of the corresponding pair of input indicators displays the first predetermined single color, the second input indicator of the corresponding pair of input indicators displays the second predetermined single color, the corresponding pivoting mechanism causes the corresponding prism to be placed in the path of the light beams transmitted from the corresponding pair of input ports, the first output indicator of the corresponding pair of output indicators displays the second predetermined single color, and the second output indicator of the corresponding pair of output indicators displays the first predetermined single color of the corresponding pair of input indicators.

5. The optical switch as described in claim 4, wherein the first and second input indicators each are generally single color light-emitting diodes.

6. The optical switch as described in claim 4, wherein the first and second output indicators each are generally double color light-emitting diodes.

7. A method of identifying optical paths through colors, comprising the steps of:
providing an optical switch with an input collimator means and an output collimator means;
attaching a plurality of input fibers to said input collimator means;
attaching a plurality of output fibers to said output collimator means;
providing switching means moveably positioned between said input collimator means and said output collimator means;
providing an internal circuit relating to condition of said switching means;
providing a plurality of input indicators displaying mutually exclusive different colors corresponding to the input fibers, respectively;
providing a plurality of output indicators corresponding to the output fibers;
displaying said mutually exclusive different colors on said output indicators, respectively, in different arrangements according to the condition of said switching means.
